(19) United States
(12) Patent Application Publication
(10) Pub. No.: US 2014/0131378 A1
(43) Pub. Date: May 15, 2014

(54) AUTOMATIC PILL DISPENSER

(71) Applicant: HON HAI PRECISION INDUSTRY CO., LTD., New Taipei (TW)

(72) Inventors: CHAO-WEN SHIH, New Taipei (TW); KUO-MING LAI, New Taipei (TW); PEI-YI CHAN, New Taipei (TW)

(21) Appl. No.: 13/931,451

(22) Filed: Jun. 28, 2013

(30) Foreign Application Priority Data
Nov. 13, 2012 (TW) 101142181

(51) Int. Cl. G07F 17/00

(52) U.S. Cl. CPC G07F 17/0092
USPC 221/211; 221/258

(57) ABSTRACT

An automatic pill dispenser includes a chassis, a pill dispensing box located on the chassis, a pill box located on the chassis for a plurality of pills, and a pill fetching assembly. The pill fetching assembly is located on the chassis. The pill fetching assembly includes a driving device and a fetching device. The fetching device includes a boom and an arm assembly. The arm assembly is located on an end of the boom to fetch the plurality of pills from the pill box. The driving device includes a cam adjacent to the boom. The fetching device rotates relative to the chassis in a horizontal plane. The cam urges the fetching device to rotate within a vertical plane.

### BACKGROUND

1. Technical Field

The disclosure generally relates to pill dispensing apparatuses, and particularly to an automatic pill dispenser.

2. Description of Related Art

It is common for the elderly or infirm to ingest many different pills according to a schedule. The schedule can be complex and involve taking medications in varying amounts at differing times. Such complexities can be difficult to remember and can result in dangerous mistakes. Therefore, it is important to provide a new and novel method and apparatus for accurately dispensing varying doses of medications.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an assembled, isometric view of an automatic pill dispenser in one embodiment.

FIG. 2 is an exploded, isometric view of the automatic pill dispenser of FIG. 1.

FIG. 3 is an isometric view of a pill fetching assembly of the automatic pill dispenser of FIG. 2.

FIG. 4 is similar to FIG. 3, but shown from another aspect.

FIG. 5 is a partially assembled view of the pill fetching assembly and an enclosure of the pill fetching device of FIG. 2.

FIG. 6 is similar to FIG. 1, but shown from another aspect.

FIG. 7 to FIG. 10 are sketch views of the pill fetching device of FIG. 6, showing a cam, a fetching device, and a pill box in different working states.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

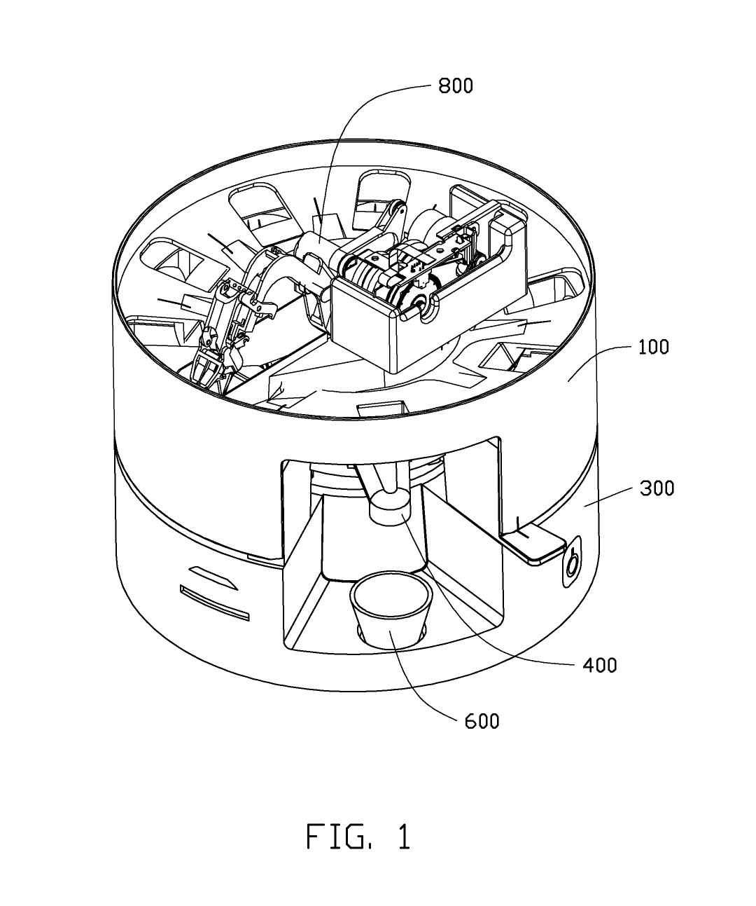

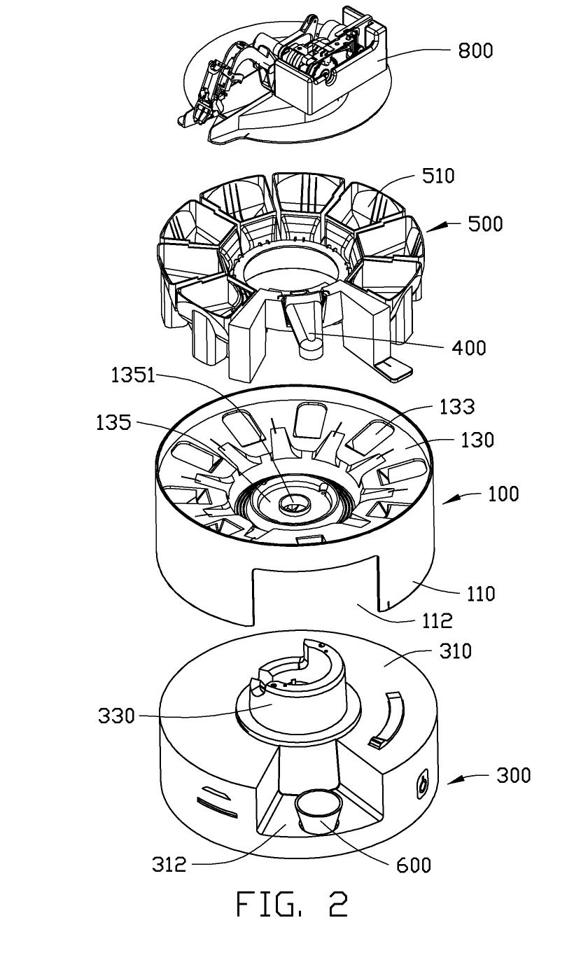

FIG. 1 and FIG. 2 illustrate one embodiment of an automatic pill dispenser. The automatic pill dispenser includes an enclosure 100, a chassis 300, a plurality of pill boxes 500, a pill dispensing box 600, and a pill fetching assembly 800.

The enclosure 100 includes a circled sidewall 110 and a supporting board 130. An outlet opening 112 is defined in the circled sidewall 110. A rotation base 135 is located in a center of the supporting board 130. A through hole 1351 is defined in the center of the rotation base 135. A plurality of fetching holes 133 is defined in the supporting board 130.

The chassis 300 is columnar and includes a base 310 and a mounting portion 330 located in a center of the base 310. A fetching recess 312 is defined in the base 310. The pill dispensing box 600 is located in the fetching recess 312. The pill dispensing box 600 has a funnel mouth.

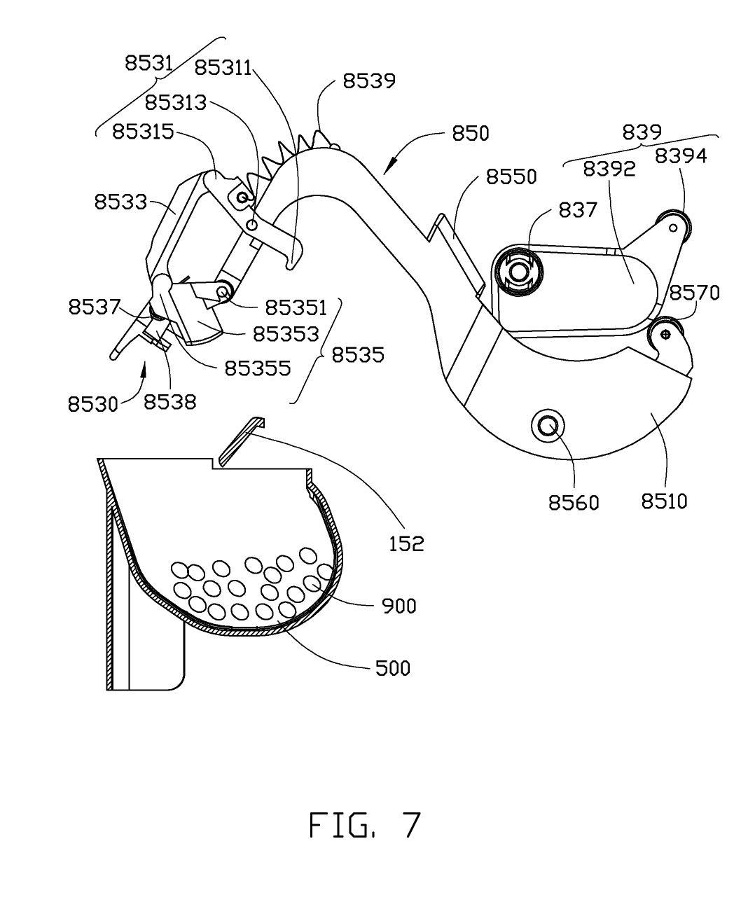

The plurality of pill boxes 500 is arranged in a circle. A width of each pill box 500 is wider at an outer side of the circle than an inner side. Each pill box 500 includes an oblique surface 510 to concentrate a plurality of pills 900 (as shown in FIG. 7).

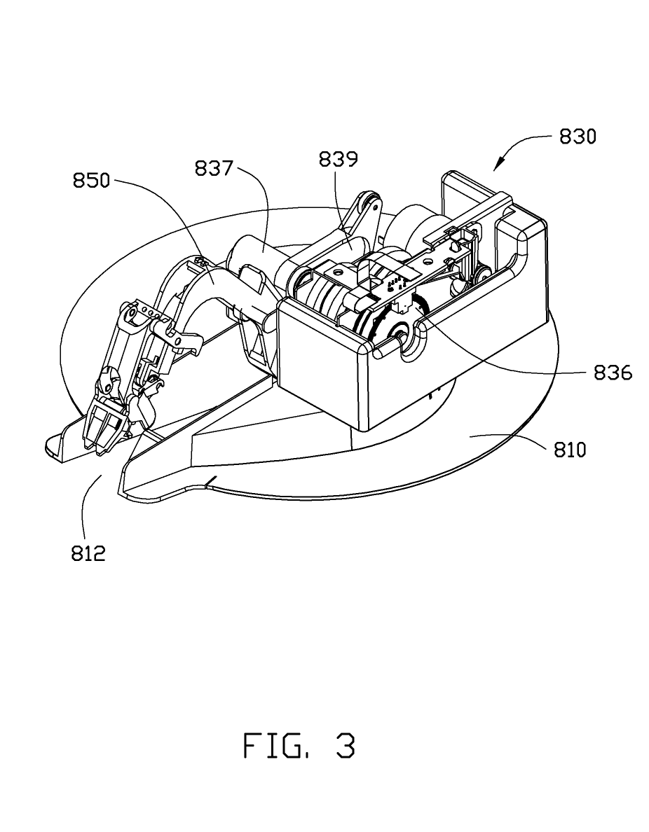

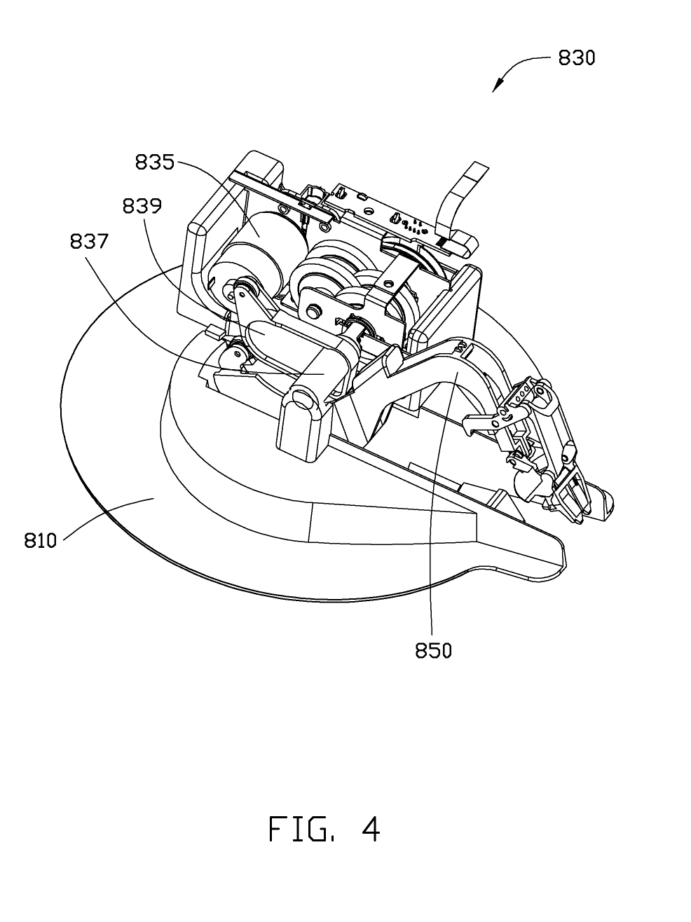

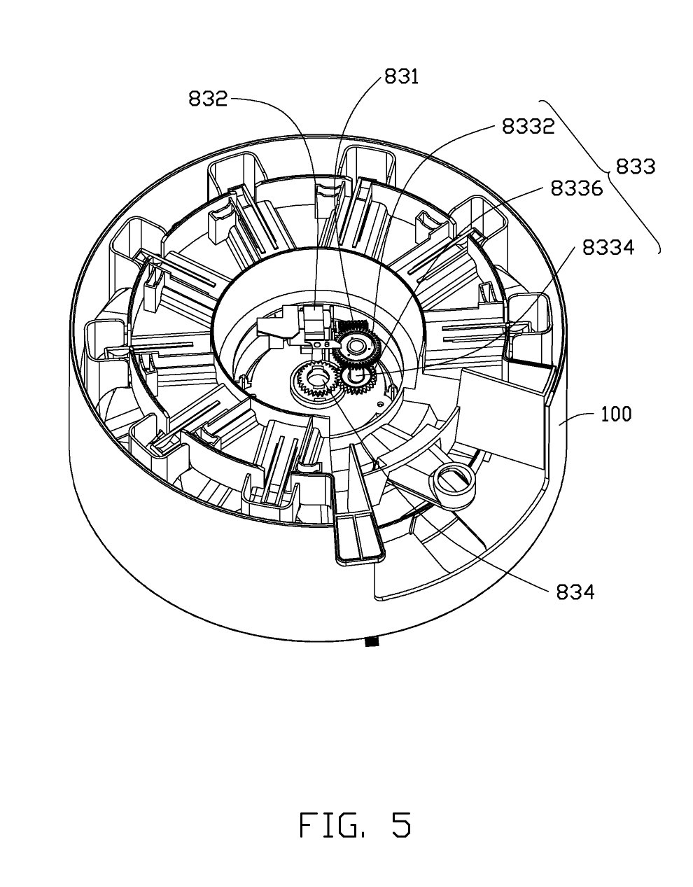

FIG. 3 to FIG. 5 illustrate the pill fetching assembly 800 in one embodiment. The pill fetching assembly 800 includes a tray 810, a driving device 830, and a fetching device 850.

The tray 810 is substantially a disk. A slot 812 is defined in the tray 810. An annular engaging portion 834 is located on a bottom of the tray 810. The annular engaging portion 834 includes a plurality of outer teeth.

FIG. 7 illustrates a lateral sketch view of the pill fetching device 800 and the pill box 500. The driving device 830 includes a first motor 832, a worm 831, a first gear set 833, a second motor 835, a second gear set 836, a first shaft 837, and a cam 839. The first motor 832, the worm 831, and the first gear set 833 are located on a bottom side of the tray 810. The first motor 832 drives the worm 831 to rotate. The first gear set 833 includes a first gear 8332, a second gear 8336, and a first pin 8334 connecting the first gear 8332 to the second gear 8336. The worm 831 engages with the first gear 8332. The second gear 8336 engages with the annular engaging portion 834. The annular engaging portion 834 is static relative to the enclosure 100. When the first motor 832 drives the worm 831 and the first gear set 833 to rotate, the first gear set 833 drives the pill fetching assembly 800 to rotate around the static annular engaging portion 834.

The second gear set 836 is driven by the second motor 835. The second gear set 836 drives the first shaft 837 to rotate, causing the cam 839 to rotate about the first shaft 837. The cam 839 includes a cam body 8392 and a first wheel 8394 located on one side of the cam body 8392. A greatest rotating angle of the cam 839 is substantially greater than 180 degrees. The first motor 832 and the second motor 835 are electrically connected to a control module. The control module controls the power of the first motor 832 and the second motor 835 to accurately adjust a rotating angle of the pill fetching assembly 800 and a rotating angle of the first shaft 837.

The fetching device 850 includes a boom 8510 and an arm assembly 8530 located on one end of the boom 8510.

The boom 8510 is sigmoid and can pivot about a second shaft 8560. A second wheel 8570 is located on the boom 8510 on an end opposite to the arm assembly 8530. A pressing portion 8550 is formed on the boom 8510.

The arm assembly 8530 includes a first arm 8531, a second arm 8535, a connecting arm 8533, and a shovel 8538. The first arm 8531 and the second arm 8535 are pivotable about the boom 8510. The first arm 8531 pivots about a first pivot portion 85313, and the second arm 8535 pivots about a second pivot portion 85351. The first arm 8531 includes a lifting portion 85311 and a first connecting portion 85315. A resilient element 8539 is connected to the first arm 8531 and the boom 8510. The lifting portion 85311 and the resilient element 8539 are located on opposite sides of the first pivot portion 85313. The second arm 8535 includes a second arm body 85353 and a second connecting portion 85355. The connecting arm 8533 connects the first connecting portion 85315 and the second connecting portion 85355. The shovel 8538 is rotatably attached to the second arm 8535. The shovel 8538 sucks the plurality of pills 900 from the pill box 500 through a connected vacuum pipe (not shown). A coil spring 8537 is located between the shovel 8538 and the second arm 8535 to keep the shovel 8538 in contact with an inner surface of the pill box 500 when the shovel 8538 moves into the pill box 500.

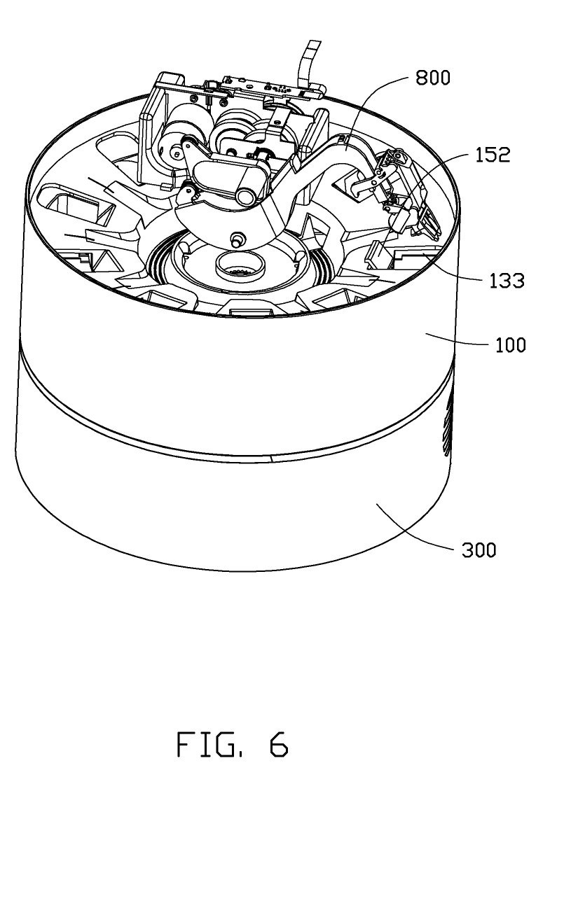

FIG. 6 illustrates an assembled view of the automatic pill dispenser. In assembly, the pill dispensing box 600 is located on the chassis 300, and the plurality of pill boxes 500 is arranged on the base 310. The plurality of pill boxes 500 stores different types of pills. A pipe mouth is positioned above the pill dispensing box 600. The enclosure 100 is located on the chassis 300. Each fetching hole 133 corresponds to a pill box 500. A supporting tab 152 is located on a side of each pill box 500. The pill fetching assembly 800 is mounted to the chassis 300 and the enclosure 100.

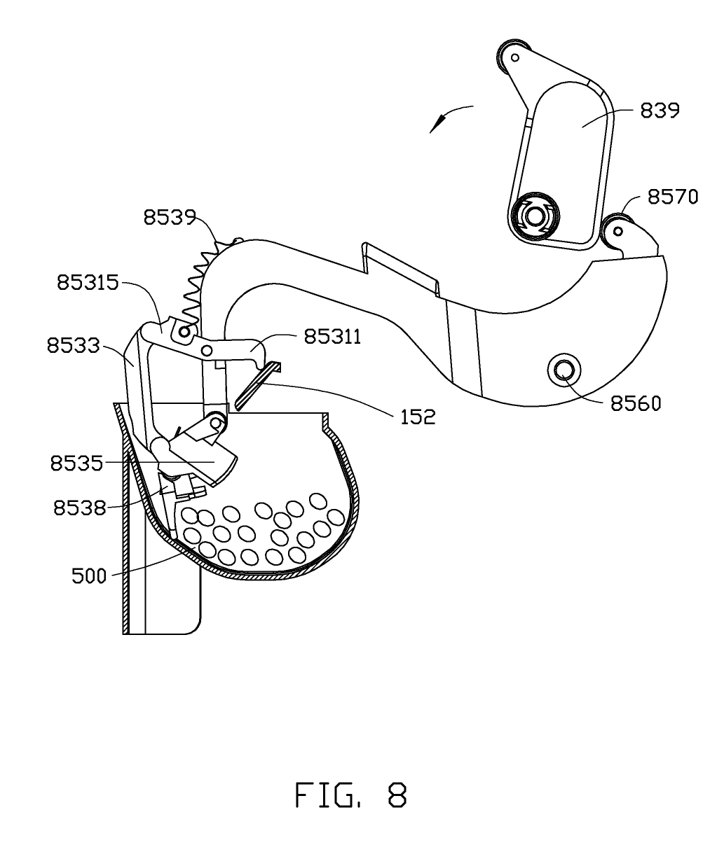

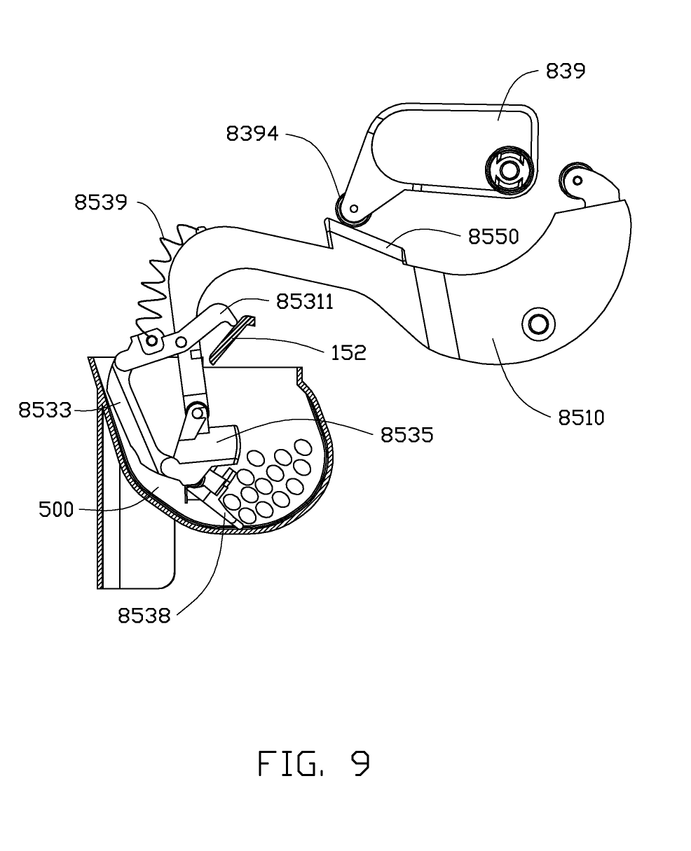

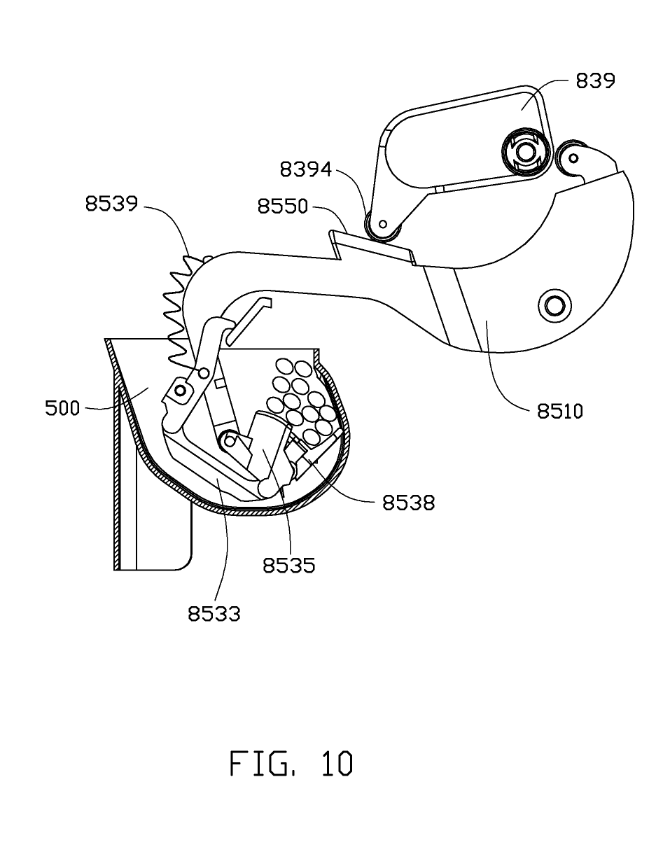

FIG. 7 to FIG. 10 illustrate different pill fetching states in one embodiment. In an original state, the end of the boom with the second wheel 8570 is lifted up to abut against an outer edge of the cam body 8392, and the arm assembly 8530 is lifted up. The arm assembly 8530 is moved to one of the pill boxes 500. The cam 839 rotates counter-clockwise away from the second wheel 8570, causing the first wheel 8394 to push down on the pressing portion 8550 and lower the arm assembly 8530 toward the pill box 500. When the lifting portion 85311 of the first arm 8531 abuts against the supporting tab 152, the left side of the fetching device 850 is supported. As the cam 839 keeps rotating counter-clockwise, the first wheel 8394 causes the shovel 8538 to move into the pill box 500 and contact the inner surface of the pill box 500. Because the supporting tab 152 abuts against the lifting portion 85311, downward movement of the arm assembly 8530 is prevented, the first arm 8531 is urged to rotate substantially about the supporting tab 152, and the shovel 8538 scoops and sucks the pills along the oblique surface 510.

To lift up the arm assembly 8530, the control module connected to the second motor 835 switches the rotating direction of the cam 839 after a predetermined time period, causing the cam 839 to rotate clock-wise. The resilient element 8539 lifts up the first arm 8531, causing the first arm 8531 to substantially pivot about the supporting tab 152. When the cam body 8392 reaches the second wheel 8570, the arm assembly 8530 is lifted up. The first motor 832 drives the fetching device 850 to rotate horizontally. When the arm assembly 8530 moves to the fetching mouth 400, the sucked pills are released and drop into the pill dispensing box 600 through the fetching mouth 400.

Thus, when the fetching device fetches the pills, the fetching device 850 rotates relative to the chassis 300 in a horizontal plane substantially parallel to the tray 810 when the first gear set 833 is driven around the annular engaging portion 834. The cam 839 urges the fetching device 850 to rotate within a vertical plane substantially perpendicular to the tray 810 when the fetching device 850 fetches the pills 900 from the pill box 500.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An automatic pill dispenser comprising:
a chassis;
a pill dispensing box located on the chassis;
a pill box located on the chassis for receiving a plurality of pills; and
a pill fetching assembly, located on the chassis, comprising a driving device and a fetching device, the fetching device comprising a boom and an arm assembly, the arm assembly located on an end of the boom to fetch the plurality of pills from the pill box, the driving device comprising a cam adjacent to the boom, the fetching device being configured to rotate relative to the chassis within a horizontal plane, and the cam being configured to urge the fetching device to rotate within a vertical plane.

2. The automatic pill dispenser of claim 1, wherein the chassis comprises an annular engaging portion, the annular engaging portion comprises a plurality of outer annular teeth, the driving device further comprises a first motor and a first gear set, the first gear set meshes with the plurality of outer annular teeth of the annular engaging portion, the first gear set is configured to rotate around the annular engaging portion with the cam and the fetching device driven by the first motor.

3. The automatic pill dispenser of claim 1, wherein the cam is configured to rotate about a first shaft, the boom is configured to rotate about a second shaft, and the first shaft is substantially parallel to the second shaft.

4. The automatic pill dispenser of claim 1, wherein a greatest rotating angle of the cam is substantially greater than 180 degrees, the cam comprises a first wheel, and the first wheel is configured to abut the boom and press down the arm assembly.

5. The automatic pill dispenser of claim 4, wherein the cam further comprises a cam body, the boom comprises a second wheel located on opposite side of the arm assembly, and the second wheel is configured to abut the cam body to lift up the arm assembly.

6. The automatic pill dispenser of claim 1, wherein the arm assembly comprises a first arm, a second arm, and a connecting arm connecting the first arm and the second arm; the first arm and the second arm are pivotable about the boom; a resilient element is connected to the first arm and the boom; and the first arm comprises a lifting portion; a supporting tab is adjacent to the pill box; and the second arm is configured to move into the pill box and the first arm is urged to rotate substantially about the supporting tab when the boom is urged by the cam, the resilient element is configured to lift up the first arm, and the first arm substantially pivots about the supporting tab when the cam release the boom.

7. The automatic pill dispenser of claim 6, wherein the arm assembly further comprises a shovel rotatable attached to the second arm, and the shovel is configured to establish a vacuum.

8. The automatic pill dispenser of claim 7, wherein a coil spring is located between the shovel and the second arm to keep the shovel contacting with an inner surface of the pill box when the shovel moves into the pill box.

9. The automatic pill dispenser of claim 6, wherein the first arm is pivot about a first pivot portion, and the lifting portion and the resilient element are located on opposite sides of the first pivot portion.

10. The automatic pill dispenser of claim 1, wherein the boom has a configuration of a substantially inverted S.

11. An automatic pill dispenser comprising:
a chassis;
a pill dispensing box located on the chassis, a supporting tab adjacent to the pill dispensing box;
a pill box located on the chassis for receiving a plurality of pills; and
a pill fetching assembly located on the chassis, the pill fetching assembly comprising a driving device and a fetching device, the fetching device comprising a boom and an arm assembly, the arm assembly located on an end of the boom to fetch the plurality of pills from the pill box;
wherein the arm assembly comprises a first arm, a second arm, and a connecting arm connecting the first arm and the second arm, the first arm and the second arm are pivotable about the boom, a resilient element is connected to the first arm and the boom, the first arm comprises a lifting portion; and the second arm is configured to move into the pill box and the first arm is urged to rotate substantially about the supporting tab when the boom is pressed down, the resilient element is configured to lift up the first arm, and the first arm substantially pivots about the supporting tab when the boom is released.

12. The automatic pill dispenser of claim 11, wherein the driving device comprises a cam adjacent to the boom, the fetching device is configured to rotate relative to the chassis within a horizontal plane, and the cam being configured to urge the fetching device to rotate within a vertical plane.

13. The automatic pill dispenser of claim 12, wherein the chassis comprises an annular engaging portion, the annular engaging portion comprises a plurality of outer annular teeth, the driving device further comprises a first motor and a first gear set, the first gear set meshes with the plurality of outer annular teeth of the annular engaging portion, the first gear set is configured to rotate around the annular engaging portion with the cam and the fetching device driven by the first motor.

14. The automatic pill dispenser of claim 12, wherein the cam is configured to rotate about a first shaft, the boom is configured to rotate about a second shaft, and the first shaft is substantially parallel to the second shaft.

15. The automatic pill dispenser of claim 12, wherein a greatest rotating angle of the cam is substantially greater than 180 degrees, the cam comprises a first wheel, and the first wheel is configured to abut the boom and press down the arm assembly.

16. The automatic pill dispenser of claim 15, wherein the cam further comprises a cam body, the boom comprises a second wheel located on opposite side of the arm assembly, and the second wheel is configured to abut the cam body to lift up the arm assembly.

17. The automatic pill dispenser of claim 11, wherein the arm assembly further comprises a shovel rotatable attached to the second arm, and the shovel is configured to establish a vacuum.

18. The automatic pill dispenser of claim 17, wherein a coil spring is located between the shovel and the second arm to keep the shovel contacting with an inner surface of the pill box when the shovel moves into the pill box.

19. The automatic pill dispenser of claim 11, wherein the first arm is pivot about a first pivot portion, and the lifting portion and the resilient element are located on opposite sides of the first pivot portion.

20. The automatic pill dispenser of claim 11, wherein the boom has a configuration of a substantially inverted S.
